(19) United States
(12) Patent Application Publication
(10) Pub. No.: US 2013/0149590 A1
(43) Pub. Date: Jun. 13, 2013

(54) ALKALI METAL-METAL HALIDE BATTERY

(71) Applicant: GENERAL ELECTRIC COMPANY, Schenectady, NY (US)

(72) Inventors: Huiqing Wu, Shanghai (CN); Mark Alan Vallance, Loudonville, NY (US)

(73) Assignee: GENERAL ELECTRIC COMPANY, Schenectady, NY (US)

(21) Appl. No.: 13/708,436

(22) Filed: Dec. 7, 2012

(30) Foreign Application Priority Data
Dec. 8, 2011 (CN) 201110404956.4

(51) Int. Cl. H01M 4/70

(52) U.S. Cl. CPC H01M 4/70
USPC 429/149; 429/211; 429/320

(57) ABSTRACT

The disclosure provides an alkali metal-metal halide battery cell. The alkali metal-metal halide battery cell comprises a separator; a cathode compartment; and an anode compartment disposed on the opposite side of said separator; wherein the cathode current collector is one of an over-sized current collector, a brush-like current collector, or a combination thereof. The battery cell has improved propertied, such as reduced internal resistance and improved discharging properties.

### BACKGROUND

Development work has been undertaken on rechargeable batteries using sodium for the anodes. Sodium has a reduction potential of 2.71 volts. Sodium is relatively low weight, relatively non-toxic, relatively abundant, available, and low in cost, especially when sodium can be introduced in the form of sodium chloride. Sodium has been used in liquid form, and the melting point of sodium is 98 degrees Celsius.

In the current designs of the sodium-metal halide battery, the current collector is generally one or two nickel rods having diameters of about 4 mm, which are positioned in the cathode compartment of the battery. It is desirable to increase the battery output power, increase capacity or extend battery lifetime.

### BRIEF DESCRIPTION

The disclosure relates to an alkali metal-metal halide battery cell comprising a separator; a cathode compartment disposed on one side of the separator, which contains a cathode material, a liquid electrolyte and a cathode current collector at least partially embedded in the cathode material; and an anode compartment disposed on the opposite side of the separator; wherein the cathode current collector is one of an over-sized current collector, a brush-like current collector or a combination thereof.

These and other features and aspects of embodiments of the disclosure may be understood more readily by reference to the following detailed description.

### BRIEF DESCRIPTION OF DRAWING FIGURES

FIG. 1 is a schematic of an alkali metal-metal halide battery cell according to one embodiment of the invention;

FIG. 2 is a view of the current collector, showing the dimensions of the current collector;

FIGS. 3a and 3b are the photos of an over-sized current collector and a brush-like current collector, respectively, according to an embodiment;

FIG. 4 shows the discharging profile of the battery cells of the Comparative Example and Examples 1 and 2 at a constant power of 155 W;

FIG. 5 shows the discharge times of the battery cells of the Comparative Example and Examples 1 and 2, after selected numbers of charging-discharging cycles, discharging to 1.8V at a power of 155 W; and

FIG. 6 is a cross-sectional top plan view of a separator of a battery cell, according to an embodiment of the invention.

### DETAILED DESCRIPTION

In the following specification and in the claims, which follow, reference will be made to a number of terms, which shall be defined to have the following meanings.

The singular forms “a”, “an”, and “the” include plural referents unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

According to an embodiment, an alkali metal-metal halide battery cell is provided that includes a separator, a cathode compartment disposed on one side of said separator, which contains a cathode material, a liquid electrolyte and a cathode current collector at least partially embedded in the cathode material, and an anode compartment disposed on the opposite side of said separator. The cathode current collector can be arranged as an over-sized current collector, a brush-like current collector or a combination thereof. A liquid electrolyte and a cathode current collector are contained in the cathode compartment, where the cathode current collector is at least partially embedded in the cathode material.

Various materials can be used as the cathode material of the alkali metal-metal halide battery. In one embodiment, the cathode material includes a first cathode material which is a transition metal and an alkali metal halide. In one embodiment, the alkali metal halide may be selected materials including an alkali metal fluoride, an alkali metal iodide, an alkali metal chloride, or a combination thereof. In another embodiment, the alkali metal halide may be selected from materials including sodium fluoride, sodium iodide, sodium metal chloride, or a combination thereof. In one embodiment, the alkali metal halide may be present in an amount of 10-90 wt %, based on the total weight of the cathode material. In another embodiment, the alkali metal halide may be present in an amount of 15-75 wt %, based on the total weight of the cathode material.

The first cathode material may be selected from materials including nickel, cobalt, iron, zinc, chromium, manganese, copper, or a combination thereof; more preferably, the first cathode material is nickel. In one embodiment, the first cathode material is present in an amount of 10-90 wt %, based on the total weight of the cathode material. In another embodiment, the first cathode material is present in an amount of 20-75 wt %, based on the total weight of the cathode material.

Optionally, the cathode material may include a second cathode material and a suitable additive to further improve the properties of the alkali metal-metal halide battery of the first aspect of the invention. In one embodiment, the optional second cathode material can be any metal different from the transition metal used in the cathode material, or it may be a non-metallic material. For example, the second cathode material can be selected from aluminum, nickel, zinc, copper, chromium, tin, arsenic, tungsten, molybdenum and iron, and the combination thereof.

In another embodiment, the cathode material may include an optional suitable additive which may include a sulfur or a phosphorous containing additive. For example, elemental sulfur, sodium sulfide or triphenyl sulfide may be disposed in the cathode.

In one embodiment, the optional second cathode material and/or additive (if present) may be present in an amount of 0-10 wt %, based on the total weight of the cathode material.

In the alkali metal-metal halide battery cell according to a first embodiment, the cathode compartment further includes a liquid electrolyte. Various liquid electrolytes may be used in the alkali metal-metal halide battery cell. In one embodiment, the liquid electrolyte can be NaAlCl₄.

A cathode current collector is also contained in the cathode compartment. In one embodiment, the ratio of the wetted cathode current collector area to the cathode volume is greater than 0.4/cm, preferably greater than 0.6/cm, and more preferably greater than 0.8/cm. The term “cathode volume” used herein refers to the total volume of the cathode and the liquid electrolyte in the cathode compartment. In the case in which the cathode compartment is a cylinder, the cathode volume is equal to the internal cross section area of the cathode volume×the height of the cathode material. The term “wetted cathode current collector area” refers to the surface area of the part of the cathode current collector in contact with the mixture of the cathode materials and the liquid electrolyte in the cathode compartment.

The mixture of the cathode materials and the liquid electrolyte can be self-supporting or liquid/molten. In one embodiment, the mixture of the cathode materials is disposed on a support structure. The support structure may be a foam, a mesh, a weave, a felt, or a plurality of packed particles, fibers, and whiskers. A suitable support structure may be formed from carbon. A suitable carbon form is reticulated vitreous carbon foam, for example.

In one embodiment, the cathode current collector used in the alkali metal-metal halide battery cell is an over-sized current collector. The term “over-sized current collector” used herein refers to the current collector having at least one dimension larger than that of a typical current collector. Specifically, in one embodiment, the over-sized current collector comprises from about 3.5% to about 25% of the volume of the cathode compartment, preferably from about 3.5% to about 11% of the volume of the cathode compartment, based on the volume of the cathode compartment. When the dimension of the cathode current collector is in the above range, the alkali metal-metal halide battery cell has excellent combined properties. For example, the internal resistance of the current collector itself is small. As the surface area of the current collector increases, the contact area between the current collector and the cathode active material also increases, which may decrease the contact resistance. The over-sized current collector surface is positioned closer to the separator between the cathode and anode, so that the conduction path length of the electrons is decreased and the ohmic voltage drop in the cathode is decreased. Nonetheless, the capacity of the battery remains high.

In one embodiment, the over-sized current collector is arranged in a U shape. The two branches of the current collector in a U shape may have the same or different diameters. In one embodiment, at least one branch (preferably two branches) of the over-sized current collector in a U shape has a diameter of greater than about 4 mm to about 10 mm, preferably from greater than about 4 mm to about 7 mm.

In one embodiment, the material of the over-sized current collector can be nickel, copper, molybdenum, tungsten, or a combination thereof It is preferable to use nickel, molybdenum, or tungsten. More preferably, the material of the over-sized current collector can be molybdenum or tungsten. In one embodiment, molybdenum coated with tungsten can also be used as the material of the over-sized current collector.

In one embodiment, the cathode current collector used in the alkali metal-metal halide battery cell is a brush-like current collector. The brush-like current collector includes a metal stem part and a metal bristle part attached to the metal stem part. The metal bristle part is configured to have from greater than 0 wt % to about 50 wt % of the total weight of the brush-like current collector, preferably from about 15 wt % to about 25 wt % of the total weight of the brush-like current collector. As exemplified below, the battery using the brush-like current collector also has excellent combined properties: the internal resistance of the battery is low, and the discharging ability is improved.

The shape of the brush-like current collector and the length, weight and/or density of the metal bristle as well as the distribution of the metal bristle on the metal stem can be selected according to the requirements.

In one embodiment, the metal stem part of the brush-like current collector can comprise about 25% or less of the volume of the cathode compartment.

In one embodiment, the metal stem part of the brush-like current collector may be a helically twisted collection of slender metal bars, where the metal bristle part may be distributed between the metal bars prior to twisting, so that the metal bristle part is attached to the metal stem part. In one embodiment, the stem can be formed by twisting two or more metal bars. In one embodiment, the effective diameter of the twisted collection of metal bars forming the helical metal stem can be selected according to the requirements, and can be less than or equal to about 10 mm, specifically between about 4 mm and 10 mm, preferably between 4 and 7 mm.

The material of the metal stem part may be nickel, copper, molybdenum, tungsten, or a combination thereof preferably, the material of the metal stem part is nickel, molybdenum, tungsten, or a combination thereof More preferably, the material of the metal stem part is molybdenum or tungsten. In one embodiment, molybdenum coated with tungsten can also be used as the material of the metal stem part.

In one embodiment, the metal bristle is substantially homogeneously distributed on the metal stem. The distributed metal bristles have the substantially same length, diameters, or the like. In one embodiment, the metal bristles may have a diameter of greater than or equal to about 0.1 mm, preferably between about 0.1 and about 1.0 mm, such as, between about 0.1 mm and 0.8 mm, between about 0.2 mm and 0.7 mm, or between about 0.3 mm and 0.5 mm.

According to embodiments of the invention, metal bristles of different materials can be used to form the brush-like current collector. In one embodiment, the material of the metal bristle part is nickel, copper, molybdenum, tungsten, or a combination thereof

In one embodiment, the metal stem part of the brush-like current collector is a helically wrapped ensemble of metal bars, the metal bristles are substantially homogeneously distributed on the metal stem, and the brush-like current collector is positioned in the center of the cathode compartment, where the metal bristles of the brush-like current collector can extend from the metal stem to the edge of the cathode compartment. In one embodiment, the brush-like current collector has an external diameter of about 2-4 cm.

In one embodiment, the cathode compartment and the anode compartment can be coaxially disposed about a central axis. The cathode compartment can be defined by the separator, which is enclosed by the anode compartment. In addition, with further reference to the separator, it can have a cross-sectional profile normal to the axis that is a circle, a triangle, a square, a cross, or a star or a clover-leaf, for example. Alternatively, the separator can be substantially planar. A planar configuration may be useful in a prismatic or button-type battery configuration. Herein “substantially planar” includes cases wherein the separator is domed or dimpled and cases wherein the separator can be flat or undulate.

The separator can be selected from among those typically used in this type of battery. In one embodiment, the separator includes a beta” alumina solid electrolyte (BASE).

In one embodiment, the separator is a solid electrolyte container which is a circular cylinder or has a cross-section selected from the group consisting of a circle, a clover-leaf shape, polygon, ellipse, and a star-shape. In one embodiment, the solid electrolyte container fits inside of an outer container having a square cross-section, for example, whose inside dimensions are about (15-60)×about (15-60) mm², preferably about 35×about 35 mm².

The battery further includes a housing. In one embodiment, the housing can be positioned outside the anode compartment to define the anode compartment. The housing can be sized and shaped to have a cross-sectional profile that is square, polygonal, or circular, and can have a length to width ratio that is in a range of 1 to 10. In some embodiments, the length to width ratio is in a range of from about 10 to about 5, from about 5 to about 1, from about 1 to about ⅕, from about 5:1 to about 10:1, from about 10:1 to about 15:1. The housing can be formed from a material that is a metal, a ceramic, or a composite. The metal can be molybdenum, nickel or steel, for example, and the ceramic can be a metal oxide, for example.

In another embodiment, an alkali metal-metal halide battery cell includes a separator, a cathode compartment disposed on one side of said separator, which contains a cathode material, a liquid electrolyte and a cathode current collector at least partially embedded in the cathode material, and an anode compartment disposed on the opposite side of said separator. The cathode current collector is an over-sized current collector, and is arranged in a U shape. The over-sized current collector can comprise from about 3.5% to about 25%, preferably from about 3.5% to about 11%, based on the volume of the cathode compartment.

According to another embodiment, an alkali metal-metal halide battery includes a separator, a cathode compartment disposed on one side of said separator, which contains a cathode material, a liquid electrolyte and a cathode current collector at least partially embedded in the cathode material, and an anode compartment disposed on the opposite side of said separator. The cathode current collector is a brush-like current collector including a metal stem part and a metal bristle part attached to the metal stem part, where the metal bristle is substantially homogeneously distributed on the metal stem, and comprises from greater than 0 wt % to about 50 wt %, preferably from about 15 wt % to about 25 wt %, based on the total weight of the brush-like current collector. The metal stem part of the brush-like current collector is a helically wrapped ensemble of metal bars, and includes about 25% or less, based on the volume of the cathode compartment.

The battery cell according to embodiments disclosed herein may carry out electrochemical reaction when in the discharged state by applying a voltage between the anode and the cathode of the electrochemical cell. Reversing the electrochemical reaction may discharge the battery. For example, when the alkali metal halide is sodium chloride, during charging, sodium chloride in the cathode is decomposed to form sodium ions and chloride ions. Sodium ions, under the influence of applied electrical potential, conduct through the separator and combine with electrons from the external circuit to form the sodium electrode and chloride ions react with the transition metal in first material to form metal chloride and donate electrons back to external circuit. During discharge, sodium ions conduct back through the separator reversing the reaction, and generate electrons. The cell reaction is as follows:

2NaCl+cathodic material−>(cathodic material)Cl₂+2Na

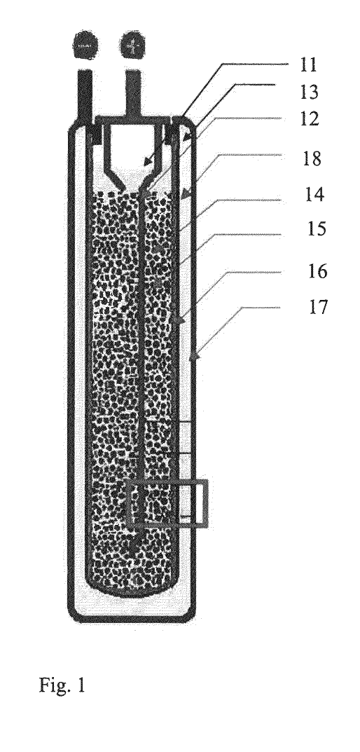

FIG. 1 shows a schematic of an alkali metal-metal halide battery cell according to one embodiment of the invention. As shown in FIG. 1, a cathode compartment 11 is disposed on one side of a separator 16, and an anode compartment 13 is disposed on the opposite side of the separator 16. The cathode compartment 11 is defined by the separator 16, which is enclosed by the anode compartment 13. The cathode compartment 11 and the anode compartment 13 are coaxially disposed about the axis of separator 16. In addition, the anode compartment 13 is defined by a housing 17 to seal it. A cathode current collector 12, a cathode material 14 and a liquid electrolyte 15 are contained in the cathode compartment 11. The cathode current collector 12 is embedded in a mixture of the cathode material 14 and the liquid electrolyte 15. An anode material 18 is contained in the anode compartment 13.

The battery cell can be used as a component of an uninterruptable power source (UPS). For example, the uninterruptable power source can be a backup power supply, including a battery and associated electronics. UPS is designed to provide power for 10 seconds to 2 hours. The battery generally discharges at a rate equal to or higher than C/2, wherein C/2 refers to the rate at which the battery discharges its nominal capacity in 2 hours.

According to another embodiment a battery pack is provided that includes one or more of the alkali metal-metal halide battery cells described herein. The battery pack may be formed only by the alkali metal-metal halide battery cells according to embodiments disclosed herein, and can also be formed by the alkali metal-metal halide battery cells in combination with battery cells of another type. A plurality of the battery cells can be combined to form the battery pack. Multiple battery cells can be arranged in series or parallel. The ratings for the power and energy of the battery pack may depend on such factors as the size or number of cells in the stack. The battery pack can also be used as an uninterruptable power source.

### EXAMPLES

Embodiments of the invention are illustrated in more detail by virtue of examples below. However, it is to be understood that these examples are merely exemplary, and shall not be construed as limiting. Unless otherwise indicated, all materials used are commercially available.

### Example 1

In this example, the separator 16 was a separator tube having a clover-leaf cross-section. The separator tube was beta” alumina The cross-section of the separator had dimensions shown in FIG. 6, in which the dimensions are in mm. The separator tube was disposed in a steel case, which had internal dimensions of about 35.5 mm (length)×35 5mm (width)×228.6 mm (height).

The mixture of the cathode material and liquid electrolyte was filled in the separator tube. The cathode material had the following composition (in wt %, based on the weight of the cathode material):
Nickel powder(Inco255): 53±2%
NaCl (99.9%): 38±2%
NaF(99.9%): 1.5±0.5%
NaI(99.9%): 0.5±0.5%
Al(99.9%): 1±0.5%
FeS(99.9%): 2±0.5%.

The cathode material was used in an amount of 235±5 g. The liquid electrolyte was NaAlCl₄ in an amount of 125±5 g.

In this example, a cathode current collector was embedded in the mixture of the cathode material and liquid electrolyte.

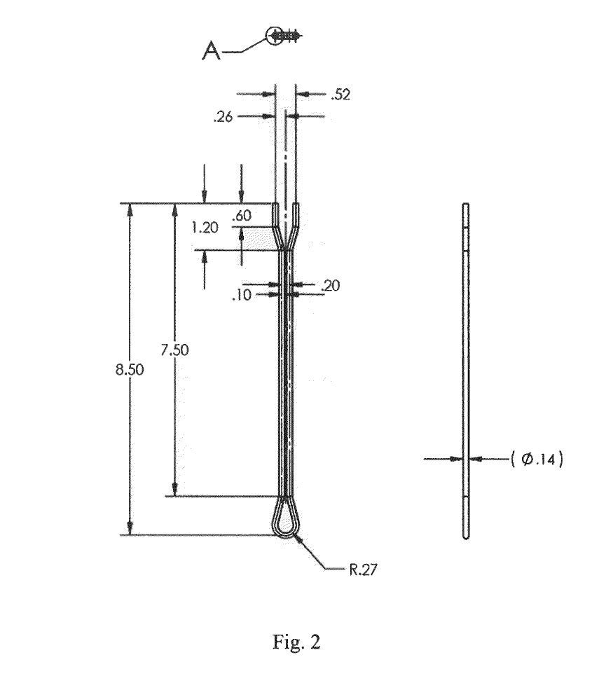

Three battery cells were tested in this example. A standard battery cell, in which a current collector made of pure nickel was used as the cathode current collector, was used as a comparative example. The dimensions of the cathode current collector in inches are shown in FIG. 2. Each leg of the current collector had a diameter of 4 mm.

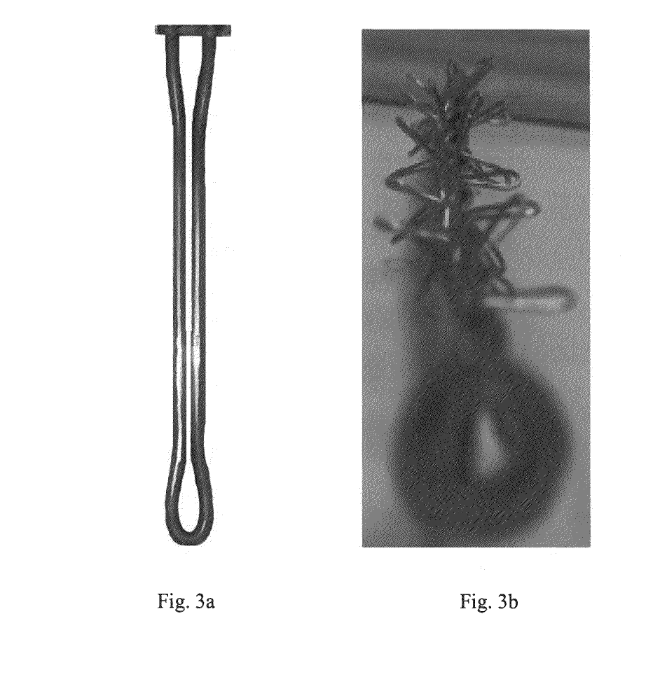

The battery cells of the two examples were the same as that of the comparative example, except that the battery cells of the two examples had the cathode current collectors shown in FIGS. 3a and 3b, respectively.

An over-sized current collector shown in FIG. 3a was used in the battery cell of Example 1 as the cathode current collector. The over-sized current collector had the same dimensions as those of the current collector shown in FIG. 2 except that each leg of the current collector had a diameter of 7 mm. The over-sized current collector size was 11%, based on the internal volume of the separator tube.

A brush-like current collector shown in FIG. 3b was used in the battery of Example 2 as the cathode current collector. The brush-like current collector had a central helically wrapped ensemble of bars having an effective diameter of 4 mm, which was made of pure nickel. The nickel bristles of the brush-like current collector had a diameter of 1 mm. The bristles were homogeneously distributed on the helically wrapped stem. The brush-like current collector had an external diameter of 4 cm (including the bristle), and a total weight of the bristles is 10 g. The center helically wrapped stem of the brush-like current collector comprised 4%, based on the volume of the separator tube.

The temperature for testing the battery cells was 300° C.

The procedure for electrochemically cycling the batteries was as follows:
Charging: the battery cells were charged to a voltage of 2.67V at a constant current of 15 A, and than were charged at a constant voltage of 2.67V until the current was less than 0.5 A.
Discharging: the battery cells were discharged at a constant power of 155 W until a voltage of 1.8V was realized.

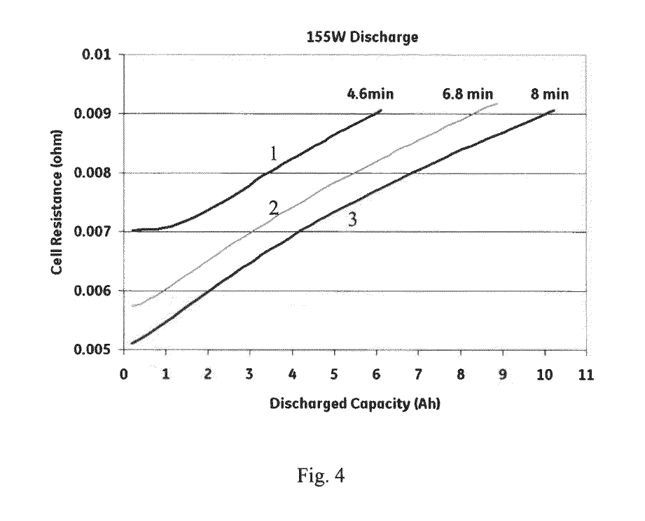

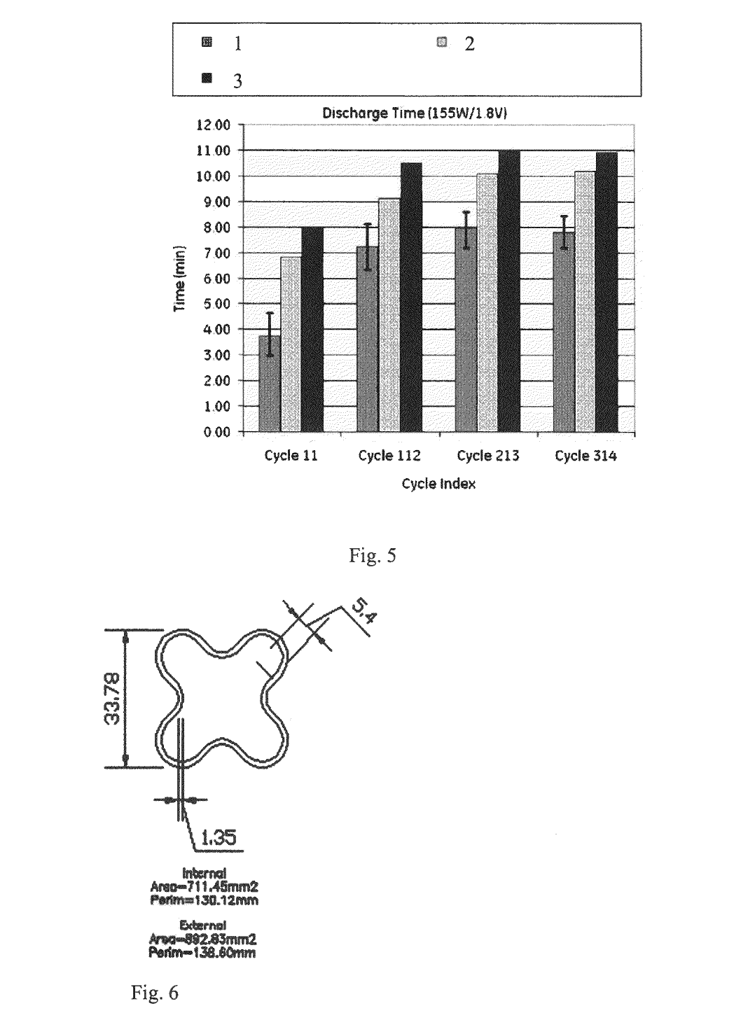

FIG. 4 shows the discharge resistance profiles of the batteries of a Comparative Example, Examples 1 and 2 discharging at a constant power of 155 W, where line 1 was the result of Comparative Example, line 2 was the result of Example 1, and line 3 was the result of Example 2. Discharge resistance is calculated as (2.58V minus cell voltage)/cell current. The duration time of each battery cell discharge to 1.8V cell voltage at 155 W is shown in FIG. 5. The discharge times are shown after various amounts of cycling. It can be seen that the batteries of Examples 1 and 2, in which the over-sized current collector and a brush-like current collector were used as the cathode current collector, respectively, had reduced internal resistance and improved discharging properties at a constant discharge power of 155 W.

The foregoing examples are merely illustrative, serving to illustrate only some of the features of the disclosure. The appended claims are intended to claim as broadly as it has been conceived and the examples herein presented are illustrative of selected embodiments from a manifold of all possible embodiments. Accordingly, it is applicants' intention that the appended claims are not to be limited by the choice of examples utilized to illustrate features of the disclosure. Where necessary, exemplary ranges have been supplied, those ranges are inclusive of all sub-ranges therebetween and are not intended to be limiting. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. An alkali metal-metal halide battery cell, comprising:
a separator;
a cathode compartment disposed on one side of the separator, which contains a cathode material, a liquid electrolyte and a cathode current collector at least partially embedded in the cathode material; and
an anode compartment disposed on the opposite side of the separator;
wherein the cathode current collector is one of an over-sized current collector, a brush-like current collector or a combination thereof

2. The alkali metal-metal halide battery cell of claim 1, wherein a ratio of a wetted cathode current collector area to the cathode volume is greater than 0.4/cm.

3. The alkali metal-metal halide battery cell of claim 1, wherein a ratio of a wetted cathode current collector area to the cathode volume is greater than 0.6/cm.

4. The alkali metal-metal halide battery cell of claim 1, wherein a ratio of a wetted cathode current collector area to the cathode volume is greater than 0.8/cm.

5. The alkali metal-metal halide battery cell of claim 1, wherein the over-sized current collector comprises from about 3.5% to about 25% of the volume of the cathode compartment.

6. The alkali metal-metal halide battery cell of claim 1, wherein the over-sized current collector comprises from about from about 3.5% to about 11% of the volume of the cathode compartment.

7. The alkali metal-metal halide battery cell of claim 1, wherein the over-sized current collector is arranged in a U shape.

8. The alkali metal-metal halide battery cell of claim 7, wherein at least one branch of the over-sized current collector in a U shape has a diameter of greater than about 4 mm to about 10 mm.

9. The alkali metal-metal halide battery cell of claim 7, wherein at least one branch of the over-sized current collector in a U shape has a diameter of greater than about 4 mm to about 7 mm.

10. The alkali metal-metal halide battery cell of claim 1, wherein the material of the over-sized current collector is selected from a group consisting of nickel, copper, molybdenum, tungsten, or a combination thereof.

11. The alkali metal-metal halide battery cell of claim 1, wherein the brush-like current collector comprises a metal stem part and a metal bristle part attached to the metal stem part, and the metal bristle part comprises from greater than 0 wt % to about 50 wt % of the total weight of the brush-like current collector.

12. The alkali metal-metal halide battery cell of claim 1, wherein the brush-like current collector comprises a metal stem part and a metal bristle part attached to the metal stem part, and the metal bristle part comprises from about 15 wt % to about 25 wt % of the total weight of the brush-like current collector.

13. The alkali metal-metal halide battery cell of claim 11, wherein the metal bristle is substantially homogeneously distributed on the metal stem.

14. The alkali metal-metal halide battery cell of claim 11, wherein the metal stem part of the brush-like current collector comprises about 25% or less of the volume of the cathode compartment.

15. The alkali metal-metal halide battery cell of claim 11, wherein the material of the metal stem part is selected from a group consisting of nickel, copper, molybdenum, tungsten, or a combination thereof, and wherein the material of the metal bristle part is selected from a group consisting of nickel, copper, molybdenum, tungsten, or a combination thereof

16. The alkali metal-metal halide battery cell of claim 1, wherein the cathode compartment is defined by the separator which is encircled by the anode compartment.

17. The alkali metal-metal halide battery cell of claim 1, wherein the separator comprises a solid electrolyte container which has a cross-section selected from the group consisting of a circle, a clover-leaf shape, polygon, ellipse, and a star-shape.

18. The alkali metal-metal halide battery cell of claim 17, wherein the solid electrolyte container fits inside of an outer container having a square cross-section.

19. The alkali metal-metal halide battery cell of claim 1, wherein the separator comprises a beta” alumina solid electrolyte.

20. The alkali metal-metal halide battery cell of claim 1, wherein the anode compartment contains an alkali metal, and wherein the alkali metal is sodium.

21. The alkali metal-metal halide battery cell of claim 1, wherein the cathode material comprises an alkali metal chloride and a metal, and wherein the metal is selected from the group consisting of nickel, cobalt, iron, zinc, chromium, manganese, copper, or the combination thereof

22. The alkali metal-metal halide battery cell of claim 1, wherein said battery cell is an uninterruptable power source.

23. An alkali metal-metal halide battery cell, comprising:
a separator;
a cathode compartment disposed on one side of the separator, which contains a cathode material, a liquid electrolyte and a cathode current collector at least partially embedded in the cathode material; and
an anode compartment disposed on the opposite side of the separator;
wherein the cathode current collector is an over-sized current collector, and wherein the over-sized current collector is arranged in a U shape and comprises from about 3.5% to about 25% of the volume of the cathode compartment.

24. The alkali metal-metal halide battery cell of claim 23, wherein the over-sized current collector is arranged in a U shape and comprises from about 3.5% to about 11% of the volume of the cathode compartment.

25. An alkali metal-metal halide battery cell, comprising:
a separator;
a cathode compartment disposed on one side of the separator, which contains a cathode material, a liquid electrolyte and a cathode current collector at least partially embedded in the cathode material; and
an anode compartment disposed on the opposite side of the separator;
wherein the cathode current collector is a brush-like current collector comprising a metal stem part and a metal bristle part attached to the metal stem part, and wherein the metal bristle is substantially homogeneously distributed on the metal stem, and comprises from greater than 0 wt % to about 50 wt % of the total weight of the brush-like current collector; and
wherein the metal stem part of the brush-like current collector is a helical metal bar, and comprises about 25% or less, based on the volume of the cathode compartment.

26. The alkali metal-metal halide battery cell of claim 25, wherein the metal bristle comprises from about 15 wt % to about 25 wt % of the total weight of the brush-like current collector.

27. A battery pack, comprising:
one or more of the alkali metal-metal halide battery cells, each comprising:
a separator;
a cathode compartment disposed on one side of the separator, which contains a cathode material, a liquid electrolyte and a cathode current collector at least partially embedded in the cathode material; and
an anode compartment disposed on the opposite side of the separator;
wherein the cathode current collector is one of an over-sized current collector, a brush-like current collector or a combination thereof.

28. The battery pack of claim 27, wherein said battery pack is an uninterruptable power source.
